(19) United States
(12) Patent Application Publication
(10) Pub. No.: US 2008/0174380 A1
(43) Pub. Date: Jul. 24, 2008

(54) METHOD AND CIRCUIT FOR PROVIDING RF ISOLATION OF A POWER SOURCE AND AN RF DEVICE EMPLOYING SUCH A CIRCUIT

(75) Inventors: Zvi NITZAN, Zofit (IL); Doron LAVEE, Karme Yosef (IL); Benyamin ALMOG, Beit Arie (IL)

Correspondence Address: KENYON & KENYON LLP, 1500 K STREET N.W., SUITE 700, WASHINGTON, DC, 20005, US

(73) Assignee: POWERID LTD., Petah Tikva (IL)

(21) Appl. No.: 11/872,928

(22) Filed: Oct. 16, 2007

Related U.S. Application Data
(60) Provisional application No. 60/829,780, filed on Oct. 17, 2006.

(51) Int. Cl. H04B 3/28

(52) U.S. Cl. 333/12

(57) ABSTRACT

A radio frequency (RF) device includes electronic circuitry having a radio frequency section and power connectors for electrically connecting the electronic circuitry to at least one power source for providing the device with power. At least one quarter wavelength transmission line is connected between the power connectors and the electronic circuitry and acts as a low-to-high impedance transformer at RF, while at low frequencies i.e. DC, it provides a physical connection. Thus, the transmission line section has substantially no effect on the DC connection between the power source and the device.

### CROSS REFERENCE TO RELATED APPLICATION

The present application claims the benefit of U.S. Provisional Patent Application No. 60/829,780, filed on Oct. 17, 2006, the disclosure of which is hereby incorporated by reference.

### FIELD OF THE INVENTION

The present invention relates in general to an RF device, and in particular to battery operated RF devices.

### BACKGROUND OF THE INVENTION

There are many examples of battery operated radio frequency (RF) devices, such as RF Short Range Devices (SRD), RF Automatic Meter Reading (AMR) devices, active RFID devices and battery assisted passive RFID devices. A problem associated with RF devices which include an RF section and a power source, is that the battery impedance and/or battery metallic parts may affect the RF section of the device. This is especially so when the device includes a larger battery. As such, it is desirable to isolate the effect of the battery impedance and/or the battery metallic parts from the RF section of the device in order to improve the performance of balanced RF components such as: amplifiers, modulators, demodulators and antennas.

Methods used to RF isolate a battery from an RF section include physical separation of the battery whereby the battery is physically remote from the RF section. An additional solution is design of the antenna to prevent the problem. However, in certain battery operated radio frequency devices, wherein the antenna cannot be easily redesigned or wherein the device is thin and flexible, these methods may not be effective.

It would be desirable to have an effective method of RF isolating a battery and a battery operated RF device comprising an isolation circuit to RF isolate the battery. The present invention provides such a method and device.

### SUMMARY OF THE INVENTION

Embodiments of the present invention provide a battery operated RF device which includes an isolation circuit to isolate the effect of battery impedance or the battery metallic parts from the RF section of the device. In some embodiments, the isolation circuit comprises a quarter wavelength section or multiple quarter wavelength sections of transmission line at the device operating frequency. A quarter wavelength section of transmission line is effective over a relatively wide frequency band, such as for example f(quarter wavelength)±7.5%. The quarter wavelength transmission line section may be constructed in any suitable configuration, size or shape. In some embodiments the quarter wavelength section may be an open quarter wavelength transmission line section or shorted quarter wavelength transmission line section or multiple quarter wavelength open or shorted transmission line sections. In some embodiments the quarter wavelength section may be folded to minimize the space required. In some embodiments, such as for example wherein there is a larger space between the power source and the RF section of the device, multiple quarter wavelength sections may be used.

The term ‘RF isolate’ as used herein refers to eliminating or reducing the effect of low battery impedance on the radio frequency of a device. Specifically, the transmission line isolates the balanced RF components from the power source so that the power source does not degrade the performance of the balanced RF components.

### BRIEF DESCRIPTION OF DRAWINGS

The principles and operation of a battery operated RF device comprising an RF isolated battery according to some non-limiting examples of the present invention may be better understood with reference to the drawings and accompanying descriptions, in which:

FIG. 1 is a schematic representation of an RF device comprising an open quarter wavelength transmission line to facilitate RF isolation of the battery according to an embodiment of the present invention;

FIG. 2 is a schematic representation of an RF device comprising a folded quarter wavelength transmission line to facilitate RF isolation of the battery according to an embodiment of the present invention;

FIG. 3 is a schematic representation of an RF device comprising two shorted quarter wavelength transmission lines to facilitate RF isolation of the battery according to an embodiment of the present invention; and

FIG. 4 is a pictorial representation of an RFID according to an embodiment of the present invention.

### DETAILED DESCRIPTION

In the following description of different embodiments of the invention, identical reference numerals will be used to refer to identical components or to components that fulfill a common function.

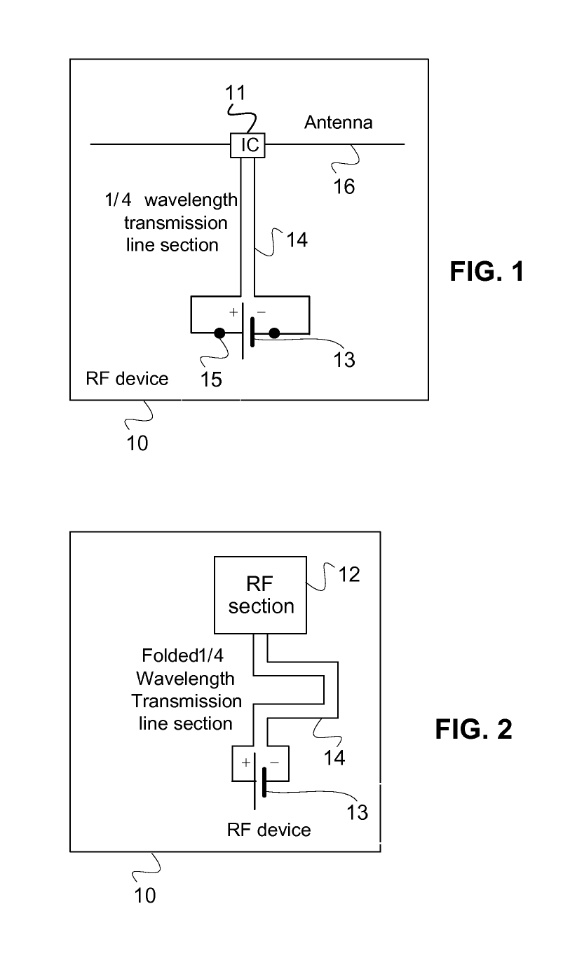

FIG. 1 shows a schematic representation of a device 10 according to one embodiment of the present invention. As can be seen from FIG. 1, the device includes electronic circuitry 11, such as an integrated circuit which includes a RF section 12 (shown in FIG. 2), at least one power source which may include a battery 13 and an isolation circuit 14 to RF isolate the at least one power source. Optionally, the power source 13 may be removably coupled to the isolation circuit 14 by respective power connectors 15. In some embodiments, device may include an antenna 16.

The isolation circuit 14 that is used to RF isolate the power source 13 may include an open quarter wavelength transmission line section. Examples of quarter wavelength transmission line section include, but are not limited to, parallel conductor section, coaxial section, strip line section, or microstrip section of transmission line. The transmission line may be constructed using any suitable technique. In one embodiment a suitable printing technology may be used and may be implemented within the printing of the device circuitry such as an etched circuit board or conductive ink printed circuit.

In some embodiments the transmission line is disposed between the RF section 12 and the at least one power source 13. The transmission line includes a first end and a second end. The transmission line may be electrically coupled such as connected at one end to the at least one power source and at a second end to the electronic circuitry. The transmission line may be folded or unfolded.

In the embodiment shown in FIG. 1, the low impedance of the battery 13 is transformed by the quarter wavelength transmission line section to high impedance with a negligible loading effect on the RF section 12 (shown in FIG. 2) of the device 10. The transmission line acts as a low-to-high impedance transformer at RF, while at low frequencies i.e. DC, it provides a physical connection. Thus, the transmission line section has substantially no effect on the DC connection between the battery 13 and the device 10.

The power source 13, which facilitates powering of the RF device, may comprise one or more suitable energy sources, such as a battery, although the RF isolation provided by the isolation circuit 14 is also effective when other energy sources are employed as described in more detail below. The power source may optionally include circuitry (not shown) configured to increase or otherwise control the supplied voltage. The battery 13 is any suitable battery of any suitable size or shape, which in some embodiments may be a thin battery. In some embodiments, the battery 13 comprises at least one thin and flexible battery, such as the batteries produced by Power Paper Ltd. (Petah-Tikva, Israel). Such thin and flexible batteries are described, for example, in U.S. Pat. Nos. 5,652,043, 5,897,522 and 5,811,204, whose disclosures are incorporated herein by reference. In some embodiments, the battery 13 may be formed using a printing process whereby the battery is printed or otherwise deposited either directly onto the same substrate as the device 10 or on a different substrate that is then mounted on or proximate to the device 10. For example, the battery 13 could be printed or otherwise deposited on an adhesive label that is then simply affixed to the device substrate using suitable means such as for example conductive ink and/or conductive adhesive. If, in such an embodiment, the transmission line is also printed or otherwise deposited on the substrate, this can be done after the battery 13 is deposited in order to ensure that the transmission line effects proper connection with the battery terminals. Alternatively, when the battery 13 is first deposited on a label, conductive tracks that are connected to the battery terminals can be formed on the lower surface of the label for contacting the transmission line. In any case, the order of depositing the battery and the transmission line is not important. In the case that the battery is printed or otherwise deposited directly on to the device substrate, discrete power connectors are not required but such connectors are nevertheless realized functionally by the isolation circuit 14 which must be electrically connected to the battery. In some embodiments, at least one of the components of device 10, such as the battery 13 may be applied in any suitable way directly on to the substrate of an end product to which the device 10 is to be attached, such as on to the packaging of goods to be tracked. Such an embodiment may facilitate a product integrally formed with the device of the present invention.

The circuitry 11 may include an integrated circuit and/or discrete components. The circuitry includes an RF section 12 (shown in FIG. 2), which may include any suitable RF components as known in the art and as used in battery operated RF devices.

FIG. 2 shows a schematic representation of a device 10 according to another embodiment of the present invention. As can be seen from FIG. 2, the device 10 is substantially the same as in FIG. 1, except that that the quarter wavelength transmission line section 14 is a folded quarter wavelength transmission line section. A folded transmission line may be used to save space.

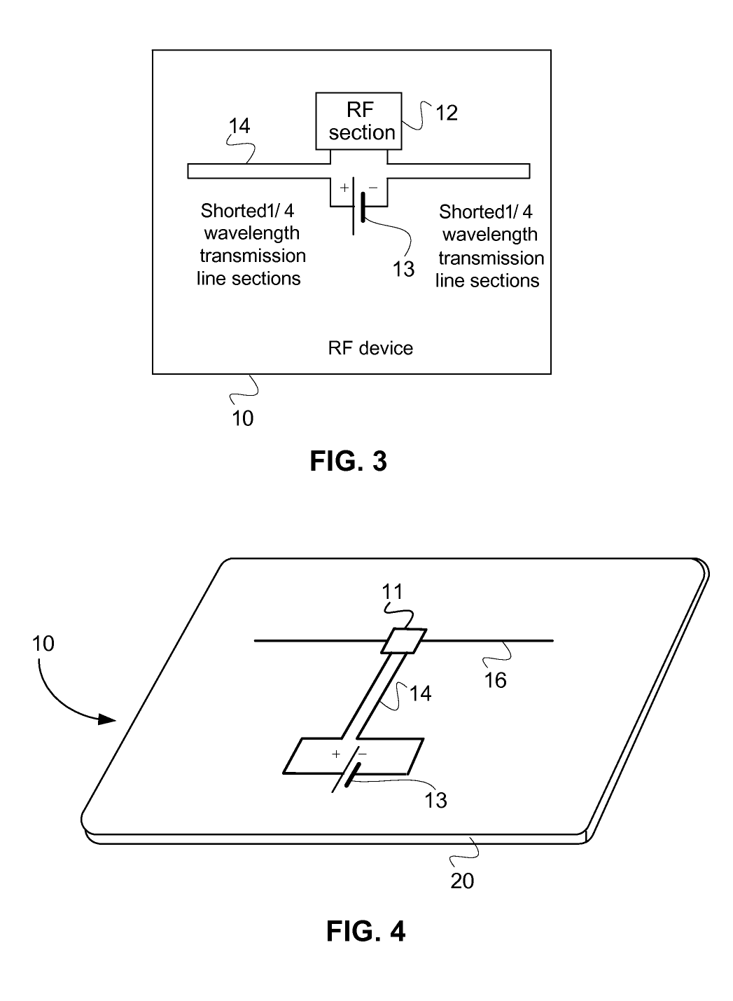

FIG. 3 shows a schematic representation of a device 10 according to another embodiment of the present invention. In the device shown in FIG. 3 the isolation circuit 14 that is used to RF isolate the power source 13 includes two shorted quarter wavelength sections. The shorted quarter wavelength sections provide very high impedance between the power connectors 15 coupled to the battery terminals and the RF section 12 of the device. In some embodiments the shorted quarter wavelength sections provide very high impedance between the battery terminals and the RF section 12 of the device. Each of the two shorted quarter wavelength transmission line sections 14 may facilitate connection of one of the terminals of the at least one power source to one terminal of the electronic circuitry. The transmission lines do not adversely affect the DC connection between the battery and the device.

FIG. 4 is a pictorial representation of an RF device 10 in the form of an RFID according to an embodiment of the present invention having a substrate 20, on which there are disposed an electronic circuit 11 comprising a radio frequency section coupled to a battery 13 via at least one quarter wavelength transmission line 14, which may be in suitable form including any of the forms described above with reference to FIGS. 1 to 3. In one embodiment, the battery 13 and the transmission line 14 are printed directly on the substrate 20. Alternatively, the battery and/or the transmission line may be deposited on an auxiliary substrate that is then mounted on or proximate to the device substrate. In some embodiments, the substrate 20 may be the substrate of an end product to which the device 10 is to be attached, such as the wrapping of goods to be tracked. In such an embodiment, device 10 may be integrally formed with the product to be tracked.

Although the invention has been described by way of example with regard to a battery-operated RF device, it will be appreciated that the ¼-wavelength transmission line may be used to isolate even a rectified mains operated AC power supply. Mains operated devices are not so sensitive to size and cost therefore other means of isolation are conventionally used such as an LC filter and/or physical separation. Thus, more generally, the invention is also applicable for use with power sources of portable RF devices other than batteries. Such power sources may be fuel cells or solar cells, where the resulting RF isolation provided by the invention will improve the device performance. Likewise, such power sources may employ a battery backup for which RF isolation is also provided.

The RF device may be an RFID device such as an RFID label. A ¼ wavelength transmission line printed on the RFID substrate, for example, has negligible effect on the form factor and the cost.

It will be appreciated that while the invention has been described with regard to an RF device having a battery or other power source for providing the device with power, the battery or other power source may be removable. For example, the power connectors 15 may serve to electrically connect positive and negative battery terminals to the electronic circuitry. In other cases, the device may include the battery or other power source as an integral unit. However, even in such cases, the battery or other power source must still be electrically connected to the electronic circuitry via the transmission line, so that the interface between the battery and the transmission line serves as the power connectors 15. In the case where the battery and the transmission line are both printed or suitably deposited on the device substrate, the power connectors may then be realized by the transmission line itself.

It will be appreciated by persons skilled in the art that the present invention is not limited to what has been particularly shown and described herein. Rather, the scope of the present invention is defined by the appended claims and includes both combinations and subcombinations of the various features described herein as well as variations and modifications thereof which would occur to persons skilled in the art upon reading the foregoing description. Accordingly, it is intended to embrace all such alternatives, modifications and variations that fall within the spirit and broad scope of the appended claims. Also it is to be understood that the phraseology and terminology employed herein is for the purpose of description only and should not be regarded as limiting.

1. A radio frequency (RF) device comprising:
electronic circuitry including a radio frequency section;
power connectors for electrically connecting the electronic circuitry to at least one power source for providing the device with power; and
at least one quarter wavelength transmission line connected at a first end thereof to the power connectors and connected at a second end thereof to the electronic circuitry.

2. The RF device according to claim 1, wherein the at least one quarter wavelength transmission line is unfolded.

3. The RF device according to claim 1, wherein the at least one quarter wavelength transmission line is folded.

4. The RF device according to claim 1, wherein the at least one quarter wavelength transmission line comprises two shorted quarter wavelength transmission line sections.

5. The RF device according to claim 4, wherein each of the two shorted quarter wavelength transmission line sections facilitates connection of one terminal of the at least one power source to one terminal of the electronic circuitry.

6. The RF device according to claim 1, further comprising an antenna.

7. The RF device according to claim 1, wherein the device is a battery assisted passive RFID device.

8. The RF device according to claim 1, wherein the at least one power source includes one or more in the group of: battery, solar cell, fuel cell and rectified AC supply.

9. The RF device according to claim 8, being integral with the at least one power source.

10. The RF device according to claim 9, wherein a battery serving at least partially as said at least one power source is printed or otherwise deposited on a substrate of the device.

11. The RF device according to claim 10, wherein the power connectors are at least partially realized by a connection between the at least one power source and the transmission line.

12. A radio frequency (RF) device comprising:
a substrate supporting electronic circuitry comprising a radio frequency section;
a battery for providing the device with power; and
at least one quarter wavelength transmission line connected at a first end thereof to the battery and connected at a second end thereof to the electronic circuitry.

13. The RF device according to claim 12, wherein at least one of the battery and transmission line is printed or otherwise deposited on the substrate.

14. The RF device according to claim 12, wherein at least one of the battery and transmission line is printed or otherwise deposited on an auxiliary substrate that is mounted on or proximate to the substrate of the device.

15. The RF device according to claim 12, wherein the substrate comprises the packaging of a product to be tracked, facilitating a product integrally formed with the radio frequency device.

16. The RF device according to claim 12, wherein the at least one quarter wavelength transmission line is unfolded.

17. The RF device according to claim 12, wherein the at least one quarter wavelength transmission line is folded.

18. The RF device according to claim 12, wherein the at least one quarter wavelength transmission line comprises two shorted quarter wavelength transmission line sections.

19. The RF device according to claim 18, wherein each of the two shorted quarter wavelength transmission line sections facilitates connection of one terminal of the at least one power source to one terminal of the electronic circuitry.

20. The RF device according to claim 12, further comprising an antenna.

21. A method of RF isolating a power source in an RF device and wherein the RF device comprises electronic circuitry comprising a radio frequency section; the power source being electrically coupled to the electronic circuitry, the method comprising:
connecting the power source to the electronic circuitry via at least one quarter wavelength transmission line.

22. The method according to claim 21, including printing or otherwise depositing a battery serving at least partially as said power source on a substrate of the device.

23. The method according to claim 21, including printing or otherwise depositing the transmission line on a substrate of the device.
